(19) United States
(12) Patent Application Publication
(10) Pub. No.: US 2012/0306261 A1
(43) Pub. Date: Dec. 6, 2012

(54) BRAKE SYSTEM HAVING A PRESSURE MODEL AND PRIORIZATION DEVICE

(75) Inventors: Heinz Leiber, Oberriexingen (DE); Christian Koeglsperger, Geretsried (DE); Anton Van Zanten, Ditzingen (DE)

(73) Assignee: IPGATE AG, Pfäffikon Sz (CH)

(21) Appl. No.: 13/577,342

(22) PCT Filed: Feb. 11, 2011
(86) PCT No.: PCT/EP2011/052053

§ 371 Date: Aug. 6, 2012

(30) Foreign Application Priority Data
Feb. 13, 2010 (DE) 10 2010 008 033.0

(51) Int. Cl. B60T 8/17; B60T 8/176; B60T 8/1755; B60T 13/74

(52) U.S. Cl. 303/146

(57) ABSTRACT

A brake system may include a brake booster, the piston-cylinder system of which is driven mechanically or hydraulically by an electric motor, in particular by means of transmission means, at least one working chamber of the piston-cylinder system being connected to at least two wheel brakes via hydraulic lines, each wheel brake being associated with a 2/2 distribution control valve and the hydraulic connecting lines between the wheels brakes and the piston-cylinder system being selectively disconnectable or jointly closable by means of the 2/2 distribution control valves such that in the wheel brakes a pressure can be adjusted consecutively in terms of a multiplex method and/or simultaneously, the electric motor and the control valves being actuated by a regulating device, characterized in that the regulating device calculates the respective pressure in the wheel brakes by means of a pressure model and transmits the calculated pressure values to at least one ABS-ESP regulator and to a pressure regulating device, wherein the pressure regulating device actuates at least the 2/2 distribution control valves and the electric motor, and a prioritization device performs a wheel selection on the basis of the data transmitted by the ABS/ESP regulator and transmits it to the pressure regulating device.

The present invention relates to a brake system according to the pre-characterising part of claim 1.

### PRIOR ART

With ABS/ESP the accuracy and the dynamics of the pressure profile determine the control quality and thus the braking distance and stability of the vehicle. A rapid and fine pressure control is decisive for a good regulation. All hydraulic systems operate with 2/2-way solenoid valves as far as the electromechanical brake EMB. The Brake Handbook, 2nd Edition, 2004, pp. 114-119 together with the literature references provides detailed basic information on this topic. Without special measures these valves have a purely digital switching behaviour, i.e. they are either open or closed (on/off). Owing to the rapid closure, large amplitude pressure fluctuations occur, depending on the pressure gradient, which affect the wheel behaviour and above all produce noise. The pressure gradient depends in this connection on the differential pressure, which varies widely in the regulation range between μ=0.05 (ice) and μ=1.0 (dry asphalt) and also depends on the widely varying THZ pressure of the brake booster. The controllability of the often synchronised pressure build-up in the range from 1 to 10 bar (target value) is achieved only relatively inaccurately. An improvement can be achieved by a complicated and expensive PWM control of the 2/2-way solenoid valves. In this way the transition in particular from the pressure build-up to pressure maintenance can be influenced, so that the pressure fluctuations and the noise become less. This PWM control is difficult and relatively inaccurate, since it has to take into account of the pressure gradient, the pressure amplitude and also the temperature. This PWM control is not used for the pressure reduction.

A method for pressure control by means of an electric motor and piston control is described in EP 06724475. In this case the HZ piston travel of the brake booster determines the pressure control and thus has considerable advantages as regards accurate pressure control and variable gradients. EP 06724475 describes also the pressure regulation of a plurality of wheel brakes by the so-called multiplex method (MUX method). Thus, it is described inter alia that the 2/2-way solenoid valves should have a large flow cross-section with a negligible throttling effect and the lines from the piston-cylinder system to the brake cylinder should have a negligible flow resistance. In addition is stated that the pressure reduction can take place simultaneously on two wheel brakes if approximately the same pressure level existed initially.

Despite these measures described in EP 06724475 the multiplex method has the disadvantage that with an unequal pressure level in two wheel brakes a simultaneous pressure reduction is not possible, since here with the dimensioning described in EP 06724475 when a pressure reduction occurs a pressure compensation can take place between two to four wheel brakes if the flow resistance from the HZ or THZ to the wheel cylinder is too low. In addition there is the fact that two or more pressure reduction requirements, which can easily occur delayed with respect to one another, also cannot be carried out simultaneously or partially simultaneously on account of the problem mentioned above of the possible pressure compensation between the wheel cylinders. This is especially problematical since in particular the time delay of pressure requirements of the same sign can repeatedly occur.

As mentioned above, pressure reductions and pressure build-ups can take place simultaneously or partially simultaneously. The term simultaneously is used if two or more solenoid valves are simultaneously opened and simultaneously closed. Partial simulation denotes the pressure setting when two or more solenoid valves are either opened in a time-delayed manner or closed in a time-delayed manner.

Furthermore, no simultaneously pressure build-up is envisaged in EP 06724475. This means that a possible brief pressure increase cannot be implemented quickly, which can possibly result in a longer braking distance.

### OBJECT OF THE INVENTION

The object of the invention is to provide an improved brake system with a regulating device, reduce costs, and optimise the braking distance and stability.

### SOLUTION OF THE OBJECT

The solution is achieved according to the invention with a brake system having the features of claim 1. Further advantageous embodiments of the brake system according to claim 1 are disclosed by the features of the subclaims.

The invention is advantageously characterised in that a pressure model is used to calculate the wheel brake pressures, whose calculated pressure values are transmitted to the ABS/ESP controller and also to the pressure control device. Pressure sensors can thereby be dispensed with and the pressure control accuracy can be increased. In addition the choice of the wheel brake or wheel brakes, in which the pressure build-up or pressure reduction is to be implemented next, is carried out by means of a prioritisation device, in particular with the aid of main criteria such as for example “optimal braking distance” and/or “stability of the control”. Likewise the decision as to whether a simultaneous, partially simultaneous or a pressure change is to take place in only one wheel brake or simultaneously is performed by the prioritisation device. This decision can take place for example on the basis of the determined slip value and/or with the aid of the instantaneous wheel acceleration or wheel deceleration.

Furthermore no pressure reduction p_{red} is permitted with an instantaneously occurring pressure build-up pᵤₚ. In order to maintain the time loss for the pressure build-up low, a high piston or pressure reduction speed with short switching times of the motor and solenoid valves is necessary. In this case, also with a subsequent pressure build-up pᵤₚ the target pressure can be increased over the operating chain pressure model-ABS/ESP controller, prioritisation device and pressure control, in order to regulate the pressure level closely up to the blocking limit.

A simultaneous or partially simultaneous pressure reduction and pressure build-up is also possible with different pressure levels of all wheel brakes. This can be achieved by correspondingly high piston speeds, the dimensioning of the flow resistances RL of the line from the 2/2-way solenoid valve to the working chamber of the piston-cylinder system (HZ and THZ) and of the flow resistance RV of the 2/2-way solenoid valve and of the hydraulic lines to the wheel cylinder. It is advantageous if the flow resistance RL is less than the flow resistance RV. It is particularly advantageous if the flow resistance RL is less than the flow resistance RV by a factor of 1.5 to 3. It is particularly advantageous if in addition the flow resistance RVR of the hydraulic line from the solenoid valve to the wheel cylinder is taken into account, in which connection this is advantageously chosen to be significantly less than the flow resistance RV of the solenoid valve.

In an improved embodiment of the invention account can be taken of the fact that the total flow resistance (RL+RV) is rated so that at maximum HZ piston dynamics, which corresponds to the maximum engine dynamics of the drive of the brake booster, and with two or more open solenoid valves, no pressure compensation can take place briefly (i.e. within the valve opening times) on account of the simultaneous volume take-up or volume release of the wheel cylinder brakes.

When designing the switching valves attention it should therefore be ensured that a very low flow resistance is achieved, which does not fall below the minimum described above. Care should also be taken to ensure that with a simultaneous pressure reduction there is sufficient pressure difference between the HZ respectively THZ and the wheel cylinders, so that in the case of a joint pressure reduction no pressure compensation can take place between the individual wheel cylinders of the wheel brakes.

A further possibility of preventing the pressure compensation with a simultaneous pressure reduction or pressure build-up is to reduce the flow cross-section of the valves via a PWM control and thereby increase the flow resistance. If for example different pressure change requirements exist for the four wheels, then the controller can on the basis of instantaneous actual pressures and the calculated individual target pressures for each wheel adjust different PWM in order to achieve different flow resistances. This preferably takes place first of all with the wheels and associated solenoid valves with the greatest pressure difference. It is advantageous in this connection that the pressure gradients can be chosen in this way depending on the situation also with simultaneous or partially simultaneous pressure build-ups and pressure reductions, and there is no adherence to the pressure profiles predetermined by the design of RL and RV and possibly RVR. Also, simultaneous and partially simultaneous pressure reductions and pressure build-ups with widely different levels can be controlled in this way in two or more wheels.

Since with a pressure reduction the maximum possible flow speed drops down to low pressures and the pressure-volume characteristics of the individual wheels are a non-linear function, a variable or different piston speed is absolutely necessary if there is a simultaneous or partially simultaneous pressure reduction and pressure build-up.

With a simultaneous or partially simultaneous pressure reduction, then as a consequence of the volume flow from the wheel cylinder into the HZ respectively THZ its piston has to be readjusted by corresponding control or regulation, in order to maintain the pressure difference. The volume thereby flowing out from the HZ or THZ into the wheel cylinder would without a readjustment of the HZ piston lead to a pressure rise and statically to a pressure compensation. This piston readjustment takes place primarily via the controller, which calculates the necessary pressure difference, accordingly determines the volume uptake in the HZ and for this purpose uses the HZ pressure and advantageously a pressure model. In the readjustment of the HZ respectively THZ piston it should be ensured that the HZ or THZ pressure always lies below the minimum pressure level of all wheel cylinders that are momentarily connected to the HZ or THZ via an open solenoid valve or switching valve. The same applies to the simultaneous or partially simultaneous pressure build-up. Here the controller in turn specifies the pressure level of the pressure rise. The HZ respectively THZ pressure is correspondingly readjusted via the piston travel and the piston speed in order to take account of the volume of the wheel cylinders of the wheel brakes for the pressure build-up. In the readjustment of the HZ piston it should be ensured that the HZ respectively THZ pressure before the pressure reduction lies in the region of the maximum pressure level of all wheel cylinders that are momentarily connected to the HZ or THZ via an open solenoid valve and during the pressure reduction p_{red} lie below the target pressure of the lowest wheel. Only when the target pressure is reached the HZ pressure is adjusted to this value.

A knowledge of the pressure-volume characteristic of the individual wheels is of great importance for the simultaneous, partially simultaneous and non-simultaneous pressure build-up, as well as for the simultaneous or partially simultaneous pressure reduction. This characteristic is recorded at interspacings for each wheel with the vehicle stationary, by measuring the volume over the corresponding piston travel and knowing the HZ pressure respectively THZ pressure. The procedure takes place with a relatively small dynamics, so that the wheel cylinder pressure corresponds to the pressure in the HZ or THZ.

As is known, with highly dynamic procedures there is a large pressure difference in the pressure control both in the pressure build-up and in the pressure reduction as a consequence of the flow resistances in the switching valve, which normally is a solenoid valve, and in the hydraulic lines to the wheel cylinder. The controller determines in each case the pressure change at the wheel brake, which is proportional to the braking moment. Therefore conventional ABS/ESP systems also with a pressure transducer at the output of the solenoid valve can measure the wheel pressure only statically. For the dynamic measurement a pressure model is used, which has a limited accuracy however. Also it is complicated to install a pressure transducer for each wheel. In the system according to the invention with piston control, the wheel cylinder pressure can however with a knowledge of the pressure-volume characteristic be accurately adjusted also with different dynamics.

With simultaneously, partially simultaneously or non-simultaneously occurring pressure build-up and pressure reduction, two or more wheel cylinders are simultaneously operated. The pressure difference predetermined by the controller is converted via the pressure-volume characteristics of the wheel into a corresponding piston travel. With the help of an additional pressure model the wheel cylinder pressure is constantly calculated. As soon as the target pressure for a wheel is reached, the respective solenoid valve is closed. The piston of the HZ or THZ then travels further so as to operate the remaining wheel cylinders. In the case of the last wheel cylinder to be regulated, the pressure control is effected via the piston travel, which was previously calculated from the pressure-volume characteristic. Following this the solenoid valve of the last wheel brake can also be closed.

The pressure model for the piston control is very important for the brake system according to the invention in connection with the simultaneous and also non-simultaneous pressure reduction and pressure build-up, since it serves for the calculation and estimation of the wheel cylinder pressures. The wheel cylinder pressures calculated in this way are used both to calculate closing and opening times of the 2/2-way solenoid valves (switching valves) and also as the actual value of the regulating quantity of the pressure controller in the multiplex process. In addition the wheel cylinder pressures from the pressure model are used in higher-level regulator structures (e.g. ABS/ESP, driver assistance functions such as ACC, etc.).

Since it is advantageous that the HZ or THZ pressure is first of all adjusted to approximately the initial pressure of the wheel cylinder to be regulated before the pressure change in the wheel cylinder, it is necessary to constantly calculate and store the wheel cylinder pressures. This task is also performed by the pressure model.

The pressure model is thus extremely important for the regulation dynamics, the noise produced in this connection and the regulation accuracy, particularly in connection with the simultaneous or partially simultaneous pressure reduction and pressure build-up.

The pressure model uses the HZ respectively THZ pressure as input signal. The various wheel cylinder pressures are then calculated from the input signal via the pressure model. The model parameters, such as for example equivalent flow resistance, equivalent line inductance and pressure-volume characteristic can in this connection be adapted via the temperature (e.g. ambient temperature or separate temperature sensor on a solenoid valve). Should changes occur in the transmission behaviour, it is also possible to adapt the parameters of the model via an adaptation.

The procedure of the simultaneous or partially simultaneous pressure change is relatively rare in the case of a normal ABS/ESP brake system, and occurs rather in limiting cases such as an asymmetrical or inhomogeneous ground surface. It is therefore very important that the multiplexer can switch as fast as possible from one wheel cylinder to the next. This is possible since the piston speed and thus the rate of the pressure change is very high and can be variably adjusted, and in this way the piston can be controlled with maximum dynamics in extreme cases. Owing to the variability it is possible in the normal case to reduce the piston speed and to access the maximum dynamics only in extreme cases. Furthermore the switching time between the start of the piston travel and the opening and closing of the solenoid valve in turn depends on the pressure difference to be controlled and the absolute pressure in the wheel cylinder.

When designing the HZ respectively THZ it should be ensured that the HZ or THZ forms as rigid a structure as possible with closed solenoid valves or switching valves, since the elasticity and rigidity of the HZ respectively THZ has a significant influence on the switching time. Ensuring as rigid an HZ respectively THZ as possible with the associated liquid volume and also with the connecting channels, e.g. RL, thus permits very short switching times.

A comparison of the wheel cylinder pressure with the HZ or THZ pressure is carried out at relatively large time intervals in order to check and if necessary correct the wheel cylinder pressures calculated by the pressure model. With the piston stationary and the solenoid valve open, a static balancing is therefore carried out after a certain pressure response time, which on account of the structure of the pressure model takes place automatically without additional adaption rules or extensions to the pressure model. The check can also take place if the wheel slip predetermined by the controller or the wheel acceleration is not reached. It is also possible, without a simultaneous or partially simultaneous pressure change, to operate only on the basis of the pressure-volume characteristic and corresponding piston adjustment in proportion to the controller requirement.

In contrast to the conventional ABS/ESP controller, which uses 12 solenoid valves and some pressure transducers for the parallel, i.e. independent pressure control, with the MUX regulator according to the invention an equivalent or even better pressure controller is possible with only four solenoid valves and an electric motor via the operating chain pressure model, ABS/ESP controller, prioritisation device and highly dynamic and accurate pressure control or pressure regulation. The individual tasks of the individual modules are described in more detail hereinafter.

Similar to the case of the ABS/ESP controller, the whole function must be fail-safe. A second computer unit MCU2 is preferably connected in parallel for this purpose, which also calculates input, output or intermediate signals or computational results via plausibility tests. If the data do not agree the whole controller is disconnected and the normal brake without controller function is engaged.

In EP 06724475 a brake system is described, in which a path simulator is used. The brake system according to the invention can also comprise a path simulator. For reasons of cost a path simulator is however dispensed with. In this case a feedback to the brake pedal can take place via the electrical drive and a mechanical connection between the brake pedal and brake booster. The described brake system can also be used as a complete brake-by-wire system without any mechanical connection to the brake pedal. It is also conceivable to use a THZ similar to the EHB in parallel with the brake system, which in the event of a failure of the described brake system delivers corresponding pressure via additional switching valves.

The invention is described in more detail hereinafter with the aid of drawings, in which:

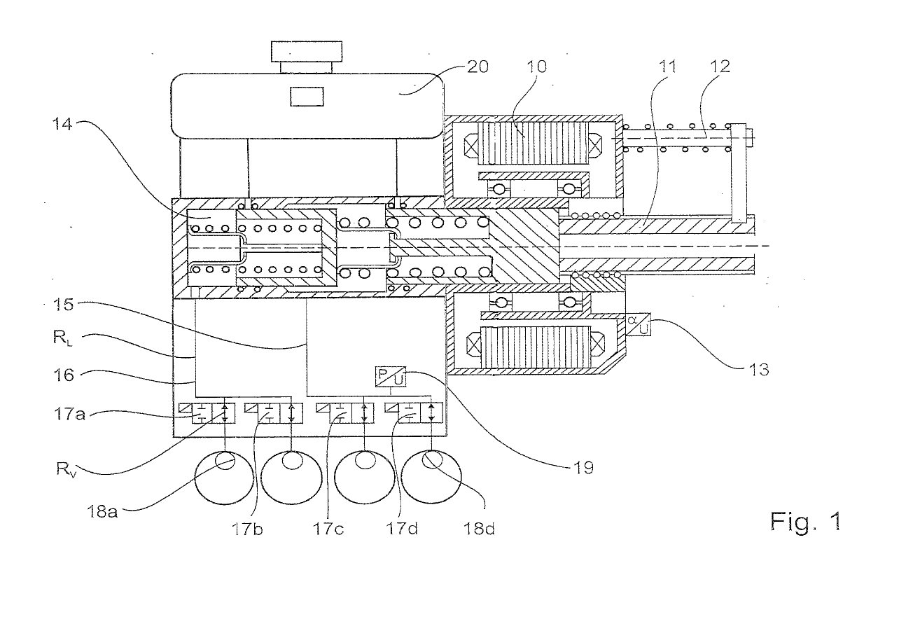

FIG. 1: shows the basic structure of the actuating mechanism for the pressure control;

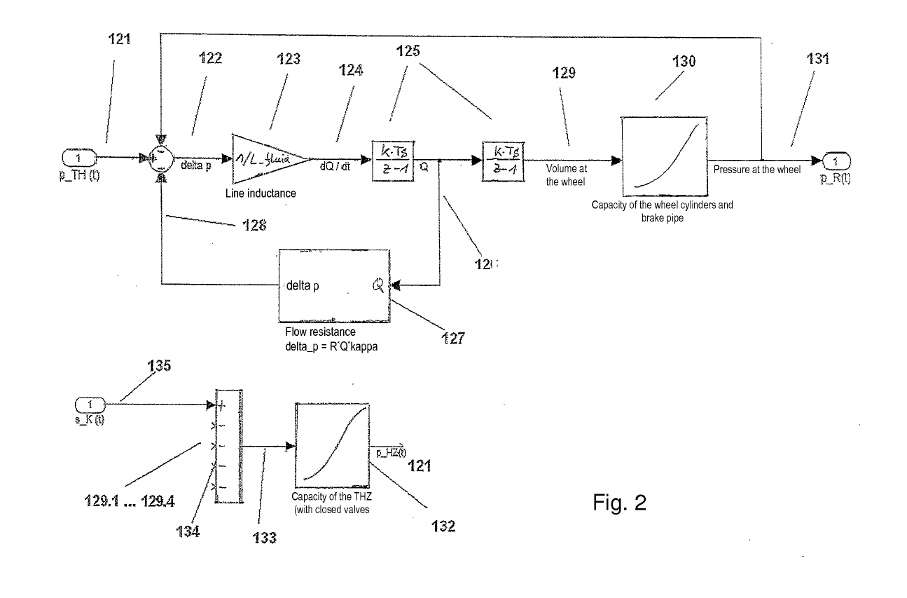

FIG. 2: is a block diagram of a pressure model;

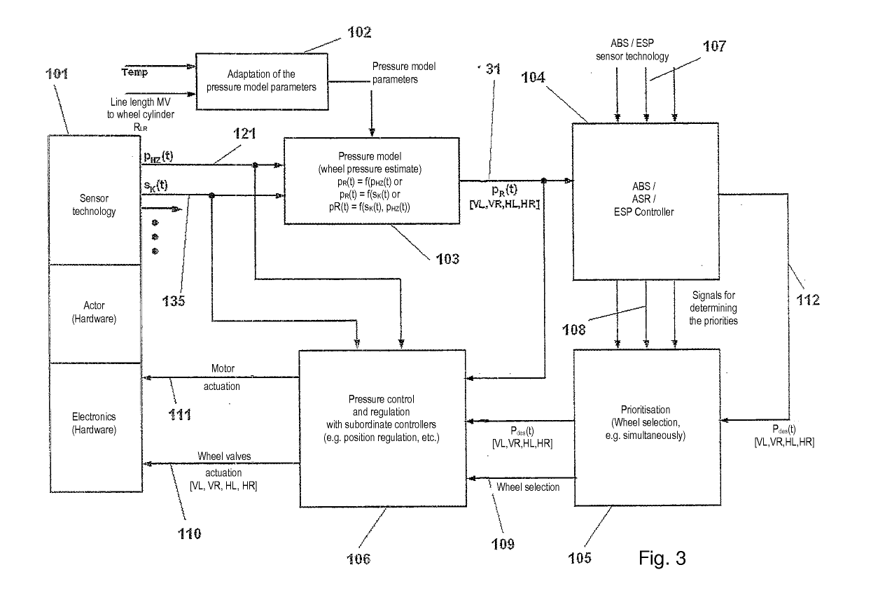

FIG. 3: is a signal flow plan of a possible software structure.

FIG. 1 shows the basic structure of the brake system according to the invention, consisting of HZ respectively THZ 14, EC motor 10, spindle 11 for driving the plunger rod piston, spindle resetting device 12, and rotational angle transducer 13 for determining the position of the piston and measuring the rotor position respectively piston travel.

If the piston receives the operational instruction to establish a specific pressure, then the corresponding piston movement is effected via the position transducer 13 and pressure transducer 19 in the plunger rod circuit, using the pressure-volume characteristic previously recorded and stored in a performance map. With the following brief constant pressure, which is generally the case in a braking operation, a correlation comparison with the stored performance map data is carried out on the basis of new measurement data. If there is a deviation the pressure-volume characteristic for each wheel brake is recorded again individually when the vehicle is subsequently stationary, and the performance map is corrected. If the deviation is significant, for example on one wheel cylinder, then technical assistance is advised.

The pressure generated in the HZ respectively in the pressure generated in the THZ passes along the lines 15, 16 from the plunger rod piston and floating piston via the 2/2-way solenoid valves 17a-d to the wheel cylinders 18a and 18d. Instead of plunger rods and floating pistons another piston arrangement or coupling by means of springs can also be employed. The plunger rod piston is advantageously rigidly connected to the spindle, so that the plunger rod piston can be retracted from a drive mode also for a rapid pressure reduction.

In this connection the dimensioning of the flow resistances RL from the HZ to the solenoid valve 17i (where i=a,b,c,d) in the lines 15 and 16 and subsequently the dimensioning of the flow resistances RV in the solenoid valve and hydraulic connection to the wheel cylinder are extremely important. Both resistances RL and RV should be low, in which connection RL should be very much less than RV and the flow resistance from the solenoid valve to the wheel cylinder RVR should be small compared to the solenoid valve, preferably

RL≦RV/factor,

where the factor should be 1.5 to 5, in particular 1.5 to 3, at room temperature. The 2/2-way solenoid valves 17a-d with the lines 15 and 16 as well as the pressure transducer 19 are preferably integrated in a block, for which purpose HZ or THZ can also be incorporated.

If an actuating instruction to reduce the pressure is issued, then the pressure adjustment is in turn carried out over the piston travel followed by the balancing with the pressure measurement. The pressure build-up and reduction correspond to the normal BKV function. For this purpose an amplification with for example the components pedal, pedal path transducer, path simulator, etc., is necessary, as is described in the aforementioned EP 6724475. The brake system of EP 6724475 includes however the pressure control and modulation and does not require all the components mentioned above.

If a pressure modulation now takes place, e.g. for the ABS/ESP function, then the MUX function is switched on. If for example the pressure should be reduced at wheel 18a, after the HZ or THZ 14 has via a motor 10 previously generated a specific pressure in the lines 15 and 16 and wheel cylinders 18b and 18d, then the solenoid valves 17b to 17d are closed.

If the pressure reduction p_{red} predetermined by the regulator is achieved over the corresponding piston travel, then the solenoid valve 17a is closed and the piston of the HZ and THZ travels to the target position predetermined by the regulator. If following this there is a pressure reduction p_{red} for example in the wheel cylinder 18d, then the solenoid valve 17d opens and the piston is driven to the new target position for the target value pᵤₚ. If a simultaneous or partially simultaneous pressure reduction p_{red} is to take place in the wheel cylinders 18a and 18b, then the solenoid valves 17a and 17b are currentless and are thus switched to the open position and the solenoid valves 17b and 17c are closed. In this case too the piston travels to the new target position. These procedures for the pressure modulation take place extremely rapidly with special switching conditions for the motor and solenoid valves. These are described in FIG. 2 and FIG. 3.

FIG. 2 shows a possible pressure model for calculating the individual wheel cylinder pressures. As input signal 121 the pressure model utilises the HZ pressure p_{HZ}(t), which corresponds (statically) to the wheel pressure in the wheel brake only in the transient state. The model 122 to 131 is implemented four times for a vehicle with four wheel brakes. Alternatively it is possible for the pressure model to calculate the HZ pressure 121 via a stored or filed pressure-volume characteristic 132 of the HZ. In this way the wheel pressure can also be adjusted dynamically via the corresponding HZ setting or piston travel. The object of the pressure model is to obtain a dynamic and very frequent estimate of the wheel cylinder pressure p_{R}(t). The function of the individual signals and signal blocks is described in more detail hereinafter.

The piston travel and the piston position sₖ(t) 135 of the HZ is used as an input signal for the pressure model 103 (see also FIG. 3). The volume in the HZ 133 is calculated via the summation point 134 from the volume at the wheel 129.1 to 129.3 and the piston travel sₖ(t) 135. The term wheel volume is understood in the contest of the invention to mean the volume of the wheel brake including the lines and the working chamber of the HZ. The HZ pressure p_{HZ}(t) 121 is calculated via the volume-pressure characteristic 132 of the HZ. An adjustment of the HZ pressure signal of the pressure sensor with the simulated signal 121 is also conceivable. This action serves to diagnose a pressure sensor failure, since the piston position of the HZ is correlated with a specific pressure via the characteristic 132. The phase current of the motor can also be used for diagnostic purposes.

If now the HZ pressure is used as input signal of the pressure model, then the signal path 135 to 121 is not necessary. The HZ pressure 121 is then obtained directly from the pressure sensor.

The differential pressure 122 is obtained via a summation site, which leads via the model block “hydraulic equivalent inductance and line inductance” 123, which stands for the mass and/or the inertia of the brake fluid, and an integrator 126 to the flow Q. The signal block 127 takes into account the flow resistance of the hydraulic path from HZ via the valve through the brake pipe up to the wheel cylinder. The model parameter equivalent flow resistance R corresponds to the hydraulic resistance of the path from the piston-cylinder system 14, HZ via the switching valve 17a, 17b, 17c, 17d up to the wheel cylinder of the wheel brake under laminar flow conditions. In addition the signal block 127 takes into account a parameter (kappa) that represents in a laminar/turbulent manner a weighting of the flow relationships within the hydraulic path from the piston-cylinder system 14, HZ via the switching valve 17a, 17b, 17c, 17d up to the wheel cylinder of the wheel brake. The actual volume at the wheel 129 is obtained from the pressure flow Q 126 via the second integrator 125, and from this is obtained, via the volume-pressure characteristic of the wheel cylinder 130, which describes the capacity and the rigidity of the wheel cylinder and the connected brake pipes, the pressure at the wheel 131. In addition there is the possibility of simulating in the pressure model 103 (see FIG. 3) the hysteresis that occurs in reality, inter alia on account of seals, etc. This increases the estimation accuracy of the pressure model. The pressure-volume characteristics that are used are in this connection are adapted and recorded statically at the vehicle start and filed/stored as a function together with the associated function parameters or as a table.

FIG. 5 shows a possible signal flow plan of the software structure. The reference numeral 101 denotes the actor p_{HZ}(t)=f(s_{K}(t)), which is illustrated in detail in FIG. 1. The sensor technology of the actor supplies the HZ pressure 121 and the HZ piston travel 135 via the evaluation performed by a rotational angle transducer. Further sensor signals, such as driver target pressure, pedal position, engine phase currents, battery currents, etc., are not included here, but can be taken into account.

The pressure model 103 calculates the various wheel brake pressures 131 from the signals 121 and 135 as a function of the chronological pressure profile p_{HZ}(t) in the HZ and/or of the DK piston travel s_{K}(t), or as a function of both, where p_{R}(t)=f(p_{HZ}) or p_{R}(t)=f(p_{HZ},s_{K}) or p_{R}(t)=f(S_{K}).

Via an adaptation the model parameters of the pressure model 103, such as for example equivalent flow resistance, equivalent line inductance and pressure-volume characteristic or pressure-volume characteristic of the wheel cylinder and of the HZ and THZ, are adapted in block 102 via the temperature, e.g. the vehicle ambient temperature, or by means of the temperature measured by a temperature sensor or at a solenoid valve or the temperature-proportional resistance measurement of the solenoid valve. The adaptation instruction can in this connection be determined in temperature experiments during the development of the system and stored. Also the parameters of the hysteresis simulation mentioned above can be adapted depending on the temperature. Various vehicle-specific parameters, such as e.g. line lengths or switch-on and switch-off time of the solenoid valve, can be measured during the initial start-up of the vehicle or programmed from a data file. For this purpose the model parameters are either filed in a table depending on the temperature, or the model parameters are calculated and transmitted to the model. If for example changes occur in the transmission behaviour, it is also possible via the adaptation to adapt the parameters of the models. The adjustment of the pressure model and thus of the parameters of the pressure model can take place repeatedly in sequence or in relatively short time intervals, if the pressure model differs from the actually measured values. The pressure model is constantly updated and is very important for the accuracy of the pressure setting, particularly in connection with the pressure modulation in the case of ESP/ABS 104 or other higher-level controllers. The wheel cylinder pressures p_{R}(t) from the pressure model are passed to the ABS/ESP controller. The ESP/ABS controller 104 and in particular the pressure control and pressure regulation 106 are referred as regulating quantities to wheel brake pressures p_{R}(t). The ESP/ABS controller calculates a wheel brake target pressure p_{des}(t) on the basis of the ABS/ESP sensor signals such as wheel speeds, transverse acceleration, yaw rate, etc., and the wheel brake pressures p_{R}(t). Alternatively the wheel brake target pressure p_{des}(t) may also be only a differential pressure or may be expanded in terms of its information content by the pressure gradient. The wheel brake target pressure is obviously calculated individually for each wheel.

In order to prioritise the processes/sequences of the pressure controller 106, the function block “prioritisation device” 105 is also connected upstream of the pressure regulator, which performs the wheel selection 109 on the basis of the various signals that are used to determine the priorities 108, for example wheel slip, parameters of the vehicle transverse dynamics, pressure regulation deviation, etc. The wheel selection specifies to the pressure controller 106 what pressure of which wheel brake(s) it must adjust next. For example, a pressure reduction requirement has higher priority than a required pressure reduction on another wheel and is therefore implemented first. Also it is not permitted for example to carry out two pressure build-ups in succession on a wheel without having performed in the meantime an operation on another wheel. The prioritisation additionally involves the decision as to whether an individual wheel or simultaneous pressure build-up or pressure reduction has to take place and how many wheels are involved in this. The wheel speed, wheel acceleration, curvilinear travel, μ jump (positive and negative), μ split carriageway and time of the regulation are preferably used as a criterion for the prioritisation. If for example it is found in the first control cycle that the desired slip or a wheel acceleration threshold has been exceeded on several wheels, then the number of involved wheels is correspondingly switched simultaneously or partially simultaneously. If during a pressure reduction of one wheel it is found that the target slip is exceeded with a higher wheel acceleration, e.g. 5 G, on another wheel, then this is regulated partially simultaneously. If the control cycle is nearly completed, switching no longer takes place. The respective target values for slip and acceleration for simultaneous or partially simultaneous actuation are altered in curvilinear travel in the sense of smaller values, in order to maintain complete stability. With higher simultaneous renewed wheel accelerations, e.g. as a result of a corresponding change in the coefficient of friction of the carriageway, a changeover can also be made with corresponding slip values to simultaneous or partially simultaneous operations. In other words, in all cases in which a gain in braking distance or driving stability can be achieved or already exists, a changeover can be made to simultaneous or partially simultaneous operations.

The respective chronological sequences as illustrated in FIGS. 2 and 3 are then calculated by the pressure control and control device 106. Here the required HZ piston travel is calculated from stored pressure-volume characteristics, taking into account the hysteresis of the wheel cylinders. An ideally subordinate position controller then adjusts the desired piston travel by control signals 11. For this purpose the respective switching valves 17a, 17b, 17c, 17d are selected 110 in the correct chronological sequence.

It is completely feasible for the pressure model 103 to be used in order to estimate future wheel pressures. This can be particularly important for the pressure control 106, in order to calculate the correct valve switching points. The determined values can in this connection be stored temporarily in a memory.

### LIST OF REFERENCE NUMERALS

1-9 Phases in the regulation cycle
p_{HZ} Main cylinder pressure
p_{R} Wheel cylinder pressure
p_{des} Wheel cylinder target pressure
p_{bui} Pressure build-up
p_{red} Pressure reduction
p*_{red} Rate of pressure change in pressure reduction
p*_{bui} Rate of pressure change in pressure build-up
sₖ HZ piston travel
s*ₖ HZ piston speed
Tₑ Transient time before valve closure
T_{Um} Switching time before start of piston travel to open the valve
T_{MUX} Total time in order to adjust the target pressure on one or more wheels
tᵥ Delay time for closing the solenoid valve
a Transition profile in the pressure-time behaviour with transient time before valve closure
b Transition profile in the pressure-time behaviour with hard valve closure without transient time
MVᵢ Solenoid valve/switching valve
U_{MV} Voltage curve for 2/2-way solenoid valve
RL Flow resistance in the line from HZ and THZ to the solenoid valve/switching valve
RV Flow resistance in the solenoid valve
RV_{R} Connecting line from the solenoid valve to the wheel cylinder
R RV+Rv_{R}+RL
10 EC motor
11 Spindle
12 Spindle reset
13 Rotational angle transducer (position transducer)
14 HZ and THZ
15 Pressure line from the plunger rod piston
16 Pressure line from the floating piston
17a-17d 2/2-way solenoid valves as switching valves
18a-18d Wheel cylinders
19 Pressure transducer
101 Actor hardware in the electronics and sensor technology
102 Software function block “calculation instructions and adaptation of the pressure model parameter”
103 Software function block “pressure model”
104 Software function block “ABS/ASR/ESP controller”
105 Software function block “prioritisation”
106 Software function block “pressure control and regulation”
107 Sensor signals of the ESP/ABS sensor technology
108 Signals for determining the priorities
109 Signal for specifying the wheel selection
110 Actuation of the switching valves
111 Actuation of the motor
112 Wheel target pressures p_{des}(t)
121 Main cylinder pressure p_{HZ}(t)
122 Differential pressure for determining the pressure flow
123 Hydraulic line inductance
124 dQ/dt
125 Integrators
126 Flow rate Q
127 Flow resistance of the path from the piston-cylinder system (14, HZ) via the switching valve (17a, 17b, 17c, 17d) up to the wheel cylinder
128 Pressure reduction at 127
129.1 Actual volume at the wheel.
130 Volume-pressure characteristic (capacity) of the wheel cylinder and of the associated connecting lines
131 Wheel cylinder pressure p_{R}(t)
132 Volume-pressure characteristic (capacity) of the main brake cylinder with closed switching valves
133 Actual volume in the main brake cylinder
134 Summation block
135 HZ piston travel s_{K}(t)

1. A brake system including:
a brake booster, including a piston-cylinder system driven mechanically or hydraulically by an electric motor the piston-cylinder system including at least one working chamber, wherein at least one working chamber of the piston-cylinder system is connected via hydraulic lines to at least two wheel brakes;
2/2-way switching valves associated respectively with wheel brakes, wherein the hydraulic connecting lines between the wheel brakes and the piston-cylinder system are closable or are closed as desired separately or jointly by means of the 2/2-way switching valves to adjust a pressure in the wheel brakes in succession in the sense of a multiplex method and/or simultaneously;
a controlling device coupled to actuate the electric motor and the switching valves, wherein the controlling device is configured to calculate, by means of a pressure model, one or more respective pressures in the wheel brakes, wherein the and the one or more calculated pressures are transmitted at least to an ABS/ESP controller and to a pressure controlling device, wherein the pressure controlling device is configured to actuate at least the 2/2-way switching valves and also the electric motor; and
a prioritisation device configured to perform a wheel selection at least on the basis of data transmitted by the ABS/ESP controller and to transmit the wheel selection to the pressure controlling device.

2. The brake system according to claim 1, the ABS/ESP controller is configured to determine at least one target pressure and/or pressure change for the wheels and wheel brakes on the basis of sensor signals and the one or more pressure values based on the pressure model.

3. The brake system according to claim 1, further comprising a computer configured to simulate the pressure model, the ABS/ESP controller and the pressure control and to perform the respective calculations.

4. The brake system according to claim 1, wherein the pressure model is configured to calculate the one or more pressures on the basis of a pressure in the at least one working chamber of the piston-cylinder system, on the basis of the piston position, or on the basis of the pressure and the piston position.

5. The brake system according to claim 4, wherein the pressure controlling device is configured to adapt parameters of the pressure model on the basis of a temperature measured in the brake system or on the basis of temperatures measured at specific points in the brake system.

6. The brake system according to claim 1, wherein the prioritisation device is configured to perform prioritisation of the wheel selection on the basis of “optimal braking distance” and/or “stability of the regulation”.

7. The brake system according to claim 1, wherein in the event of a directly occurring pressure reduction in one or more wheel brakes, the prioritisation device does not allow simultaneously a pressure build-up in one or more wheel brakes, and vice versa.

8. The brake system according to claim 1, wherein in the event of a wheel slip greater than a predetermined slip limiting value and/or with a wheel acceleration or deceleration greater than +/−10 G, the prioritisation device is configured to switch to a simultaneous or partially simultaneous pressure build-up or pressure reduction.

9. The brake system according to claim 1, further comprising a second computing unit configured to perform a plausibility examination of the input signals, output signals and/or intermediate signals of the overall system and/or of the pressure model, ABS/ESP controller, prioritisation device and pressure controlling device.
